(19) United States
(12) Patent Application Publication
(10) Pub. No.: US 2010/0073298 A1
(43) Pub. Date: Mar. 25, 2010

(54) DATA INPUT APPARATUS

(76) Inventor: No-Soo PARK, Daejeon (KR)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/516,887

(22) PCT Filed: Sep. 14, 2007
(86) PCT No.: PCT/KR2007/004442

§ 371 Date: May 29, 2009

(30) Foreign Application Priority Data
Sep. 15, 2006 (KR) 10-2006-0089806

(51) Int. Cl. G06F 3/02

(52) U.S. Cl. 345/169

(57) ABSTRACT

The present invention relates to a data input apparatus which is capable of implementing more key values even in less area and causing a key position to be confirmed easily and thereby recognizing the confirmation of the key position intuitively while minimizing movements of finger when entering the key using the finger, especially thumb. The present invention can implement more key values with less number of switches and reduce movements of fingers during input operations, since the key input switch is shared with each other. Further, the present invention can allow the input position to be confirmed easily because of the step of selecting the unit cell which is a first input step, thereby allowing blind-touch operation.

### TECHNICAL FIELD

The present invention relates to a data input apparatus, and more particularly to a data input apparatus which is capable of implementing more key values even in less area and causing a key position to be confirmed easily and thereby allowing the confirmation of the key position intuitively while minimizing movements of finger when entering the key using the finger, especially thumb.

### BACKGROUND ART

An amount of data transmission is rapidly increased using a short message service (SMS) for recent few years and an amount of data input on portable computers or PDAs is rapidly increased as a wireless internet has been activated recently. In addition, the data input on a remote controller is expected to be generalized if two-way TV is customized in the future.

At present, as general data input methods on small-sized portable machine, there are a keypad circulation method (for example, a→b→c→) which select and input a desired key value by pressing any key on the keypad several times to circulate the data, and a method of using a micro keyboard.

In a case of using the key-pad circulation method, since the key value is inputted by repeating operations of circulating the data via press operations on the selected key several times in order to input a desired key value, the key must be pressed many times per a word, which results in problems of being time-consuming to enter the key and making it easy to mistake.

In a case of using the micro keyboard, there are problems in that it is required to have more area relatively and enter the key while watching the keyboard carefully. Also, since it is needed to input more key values in UMPC, there is a difficulty in applying UMPC.

Meanwhile, as the data input method of another type using the small-sized portable machine, there is a method of selecting the cell by the touching of direction-keys on the touch pad and entering the key input switch corresponding to the selected cell in order to input the data,

In this case, since the cell is selected while moving by the touching of the direction-key and then the data is inputted from the key input switch so that the direction key and the key input switch must be alternatively entered at any time, it is difficult to adapt to operations due to a lack of consistency of finger movement upon entering the key and apply to the data input apparatus due to its complicate structure.

### DISCLOSURE

### Technical Problem

The present invention is contemplated to address the above-mentioned problems and has an object to provide a efficient small-sized data input apparatus which is capable of inputting the data more rapidly and more efficiently than a keyboard by occupying less area and implementing more key values as compared with the keyboard typically used, and of reducing movements of finger and allowing the key position to be confirmed easily upon inputting the key by implementing more key values in less area than the method of using a micro-keyboard, thereby inputting the data without watching the keyboard.

### Technical Solution

The present invention is to provide a data input apparatus which is allowed to occupy less area and input various data easily and rapidly to allow blind touch operation, that is, to input the data intuitively, comprising a key input switch which is disposed in a matrix pattern to define a unit cell by locating in an adjacent vertex of a square in which the unit cell and an adjacent unit cell share at least one or more switches with each other; and a cell select switch which is installed on a center portion of the unit cell of the key input switch and is pressed or touched to cause the unit cell to be selected and set into a key input standby state, wherein it is allowed to input a key value of the unit cell generated by a sequence pair consisted of a touching of the cell select switch and an entering of the key input switch.

Preferably, if the unit cell is activated, the key value is inputted by pressing the key input switch defining the activated unit cell.

Also, the data input apparatus further comprises a key input switch which is located on a same line as the key input switch outside the outermost-disposed key input switch to be allowed to share the cell select switch with each other.

Also, the data input apparatus further comprises one or more outermost cell select switches which are located on a same line as the cell select switch outside an outermost-disposed key input switch, wherein the outermost cell select switch is pressed or touched to cause the outermost-disposed key input switch adjacent to it to be set into a key input standby state.

Preferably, the cell select switch is pressed or touched to cause the unit cell consisted of adjacent key input switches to be activated, a key value assigned to the key input switch within the activated unit cell is inputted if a signal is inputted by pressing any one key input switch defining the activated unit cell, and the unit cell activated by touching the cell select switch remains activated until the adjacent unit cell sharing the key input switch is activated.

More preferably, the cell select is allowed which is corresponding to the cell select switch which is touch-initiated first, when two or more cell select switches are touched simultaneously. Or, the cell select is prevented, when two or more cell select switches are touched simultaneously.

More preferably, each of the key values corresponding to the unit cell selected by selecting the cell select switch is printed on a portion close to the key input switch within the corresponding unit cell.

More preferably, the key input switch has a matrix pattern disposed in a square shape selected from a group consisted of a square, rectangular, diamond and parallelogram.

More preferably, the data input apparatus which is independently operated is installed in both left and right sides respectively to be used with both hands.

### DESCRIPTION OF DRAWINGS

The above and other objects, features and advantages of the present invention will become apparent from the following description of preferred embodiments given in conjunction with the accompanying drawings, in which:

FIG. 1 is a drawing showing one embodiment of a data input apparatus according to the present invention.

FIG. 2 is a drawing showing an input example of FIG. 1(a).

FIG. 3 is a drawing showing an input example of FIG. 1(b).

FIG. 4 is a drawing showing an input example of FIG. 1(c).

FIG. 5 is a drawing showing a case of selecting a unit cell of the data input apparatus according to the present invention.

FIG. 6 is a drawing showing when entering a key of the data input apparatus according to the present invention.

FIG. 7 is a perspective view and an exploded perspective view showing the data input apparatus according to the present invention.

FIG. 8 is a drawing showing an example of applying the data input apparatus according to the present invention to a portable terminal.

FIG. 9 is a drawing showing an example of applying the data input apparatus according to the present invention to PDA.

FIG. 10 is a perspective view showing an example of applying a data input apparatus according to other aspect of the present invention.

FIG. 11 and FIG. 12 are perspective views showing an example of applying a data input apparatus according to further other aspect of the present invention.

FIG. 13 is a partial cross sectional perspective view of

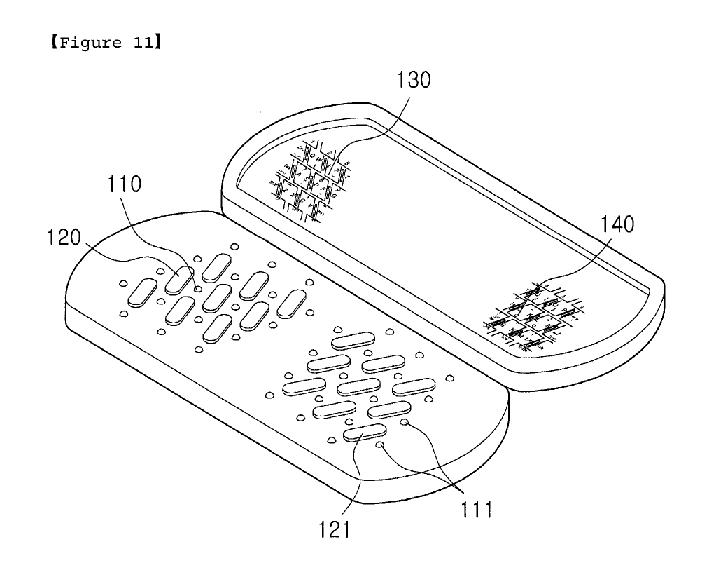

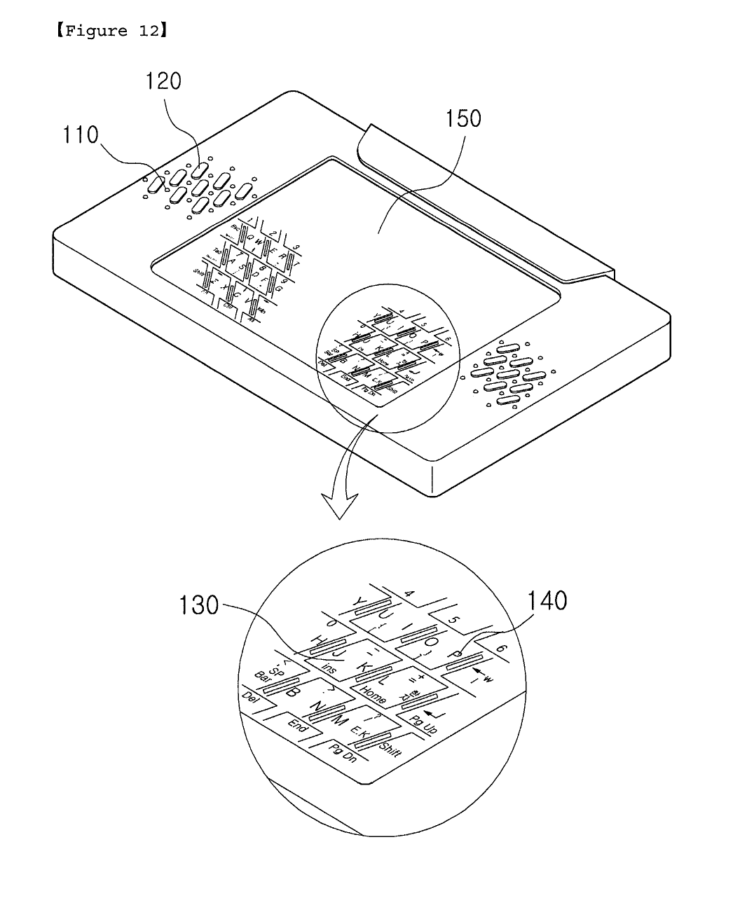

FIG. 11.

### DETAILED DESCRIPTION OF MAIN ELEMENTS

110: cell select switch
120: key input switch
130: unit cell
140: key value

### BEST MODE

Hereinafter, the embodiments of the present invention will be described in detail with reference to accompanying drawings.

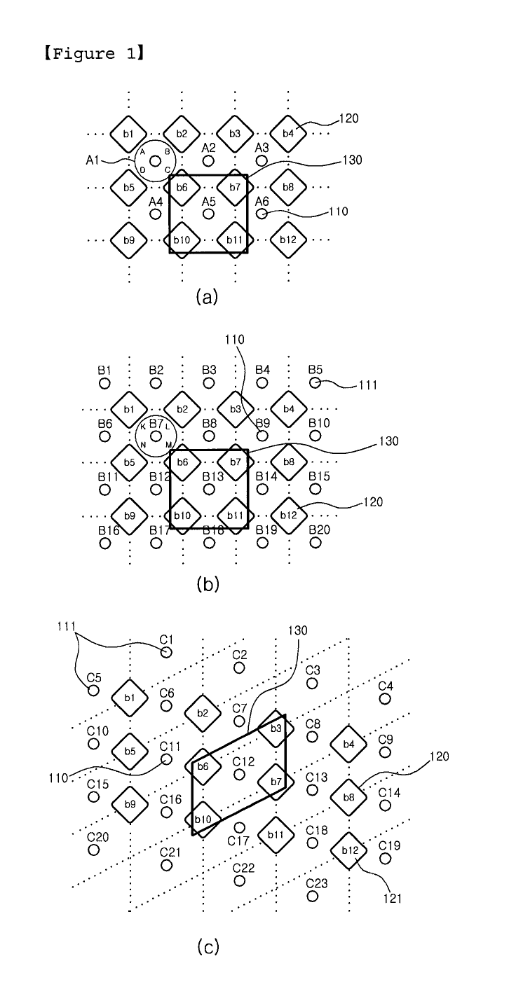

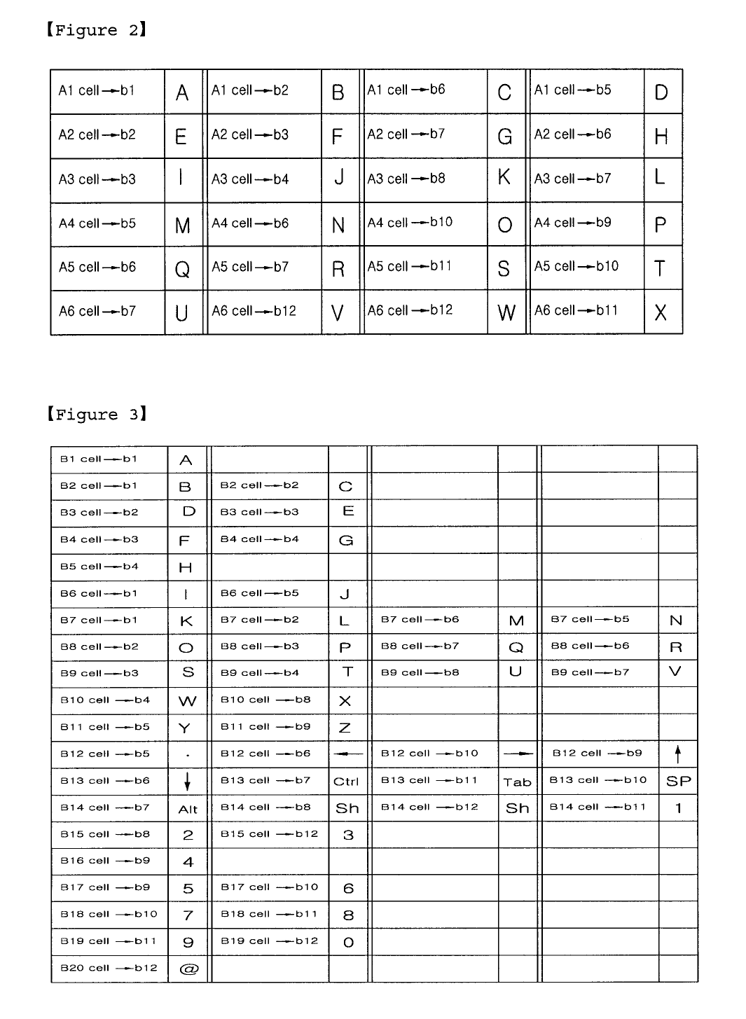

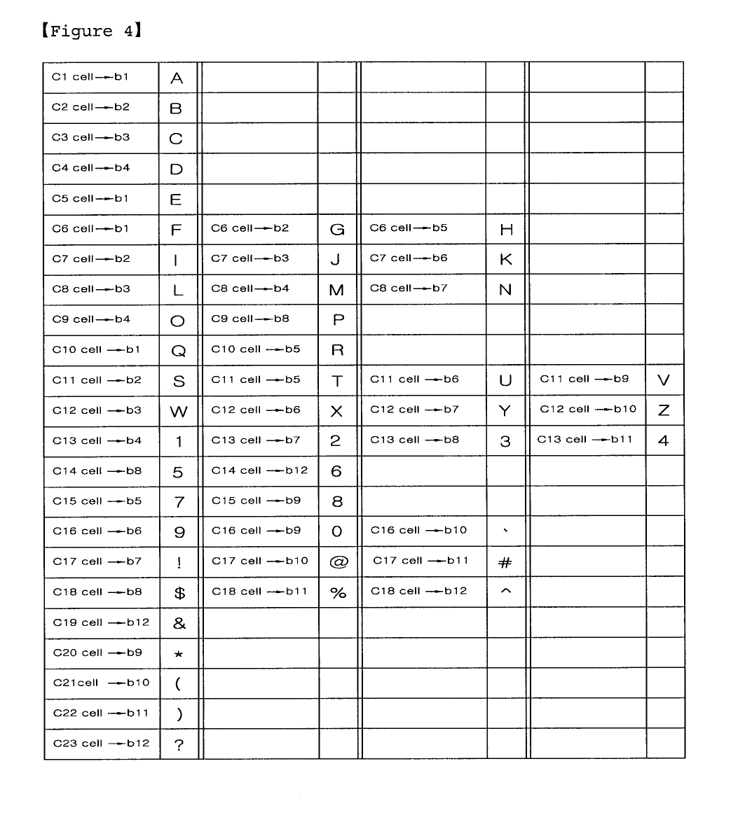

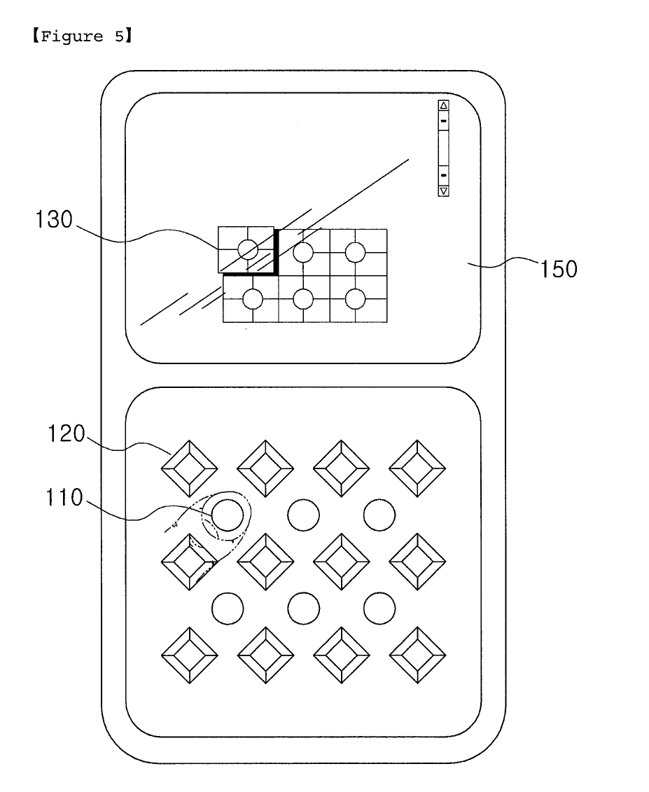

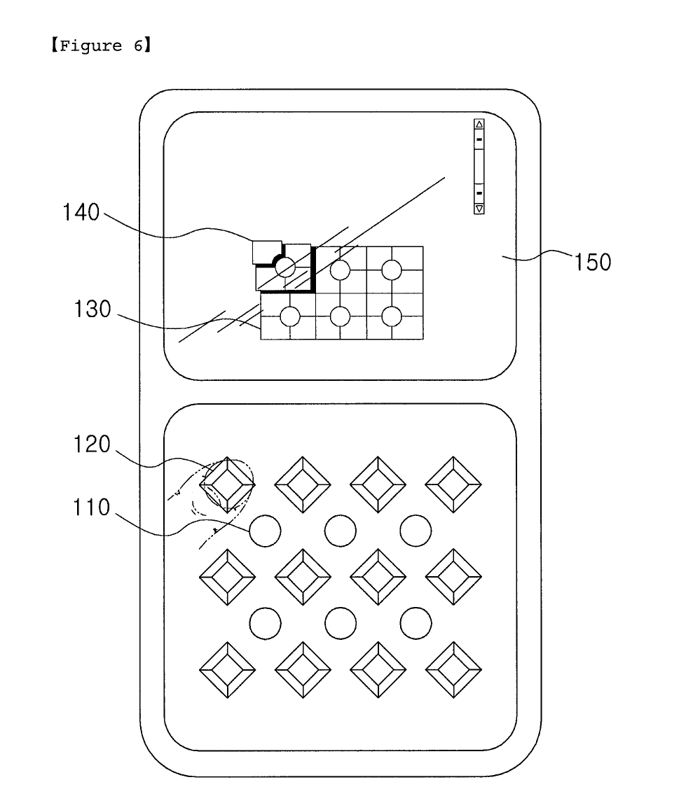

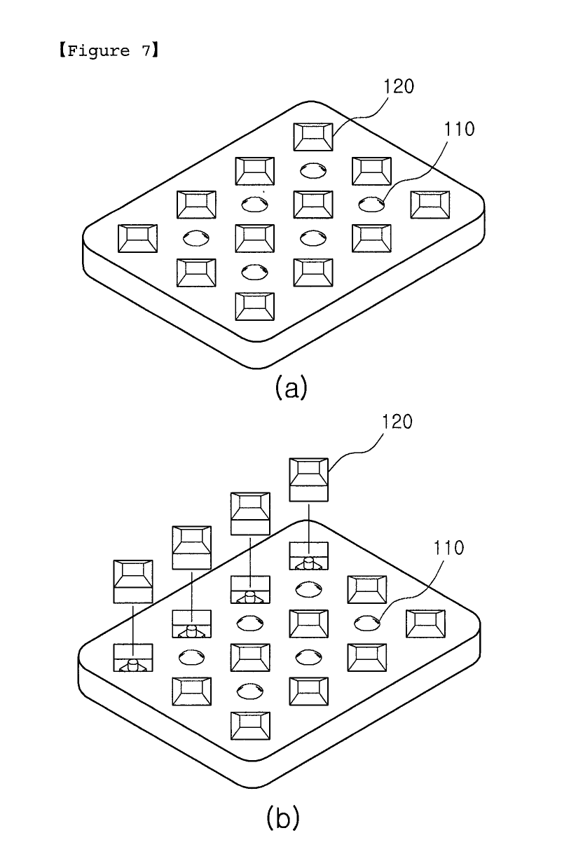

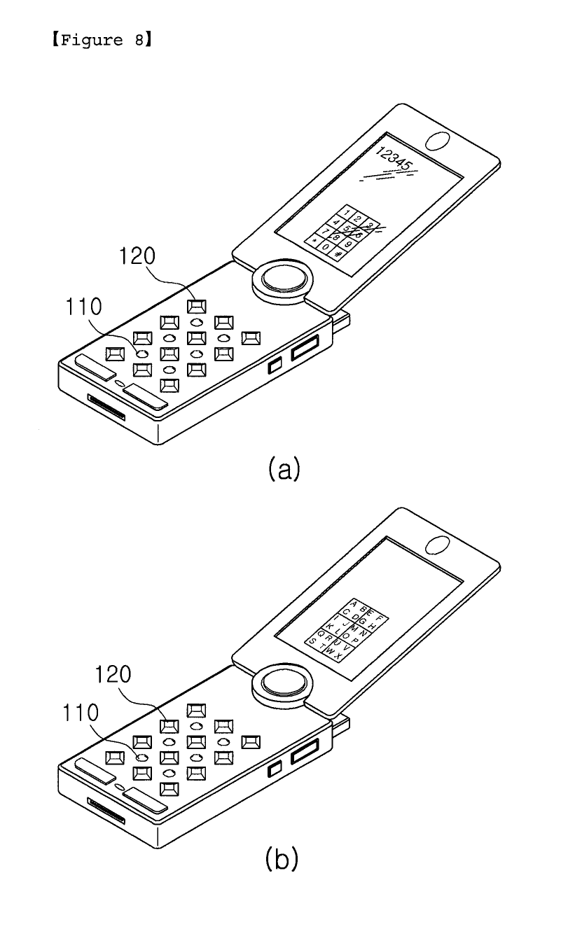

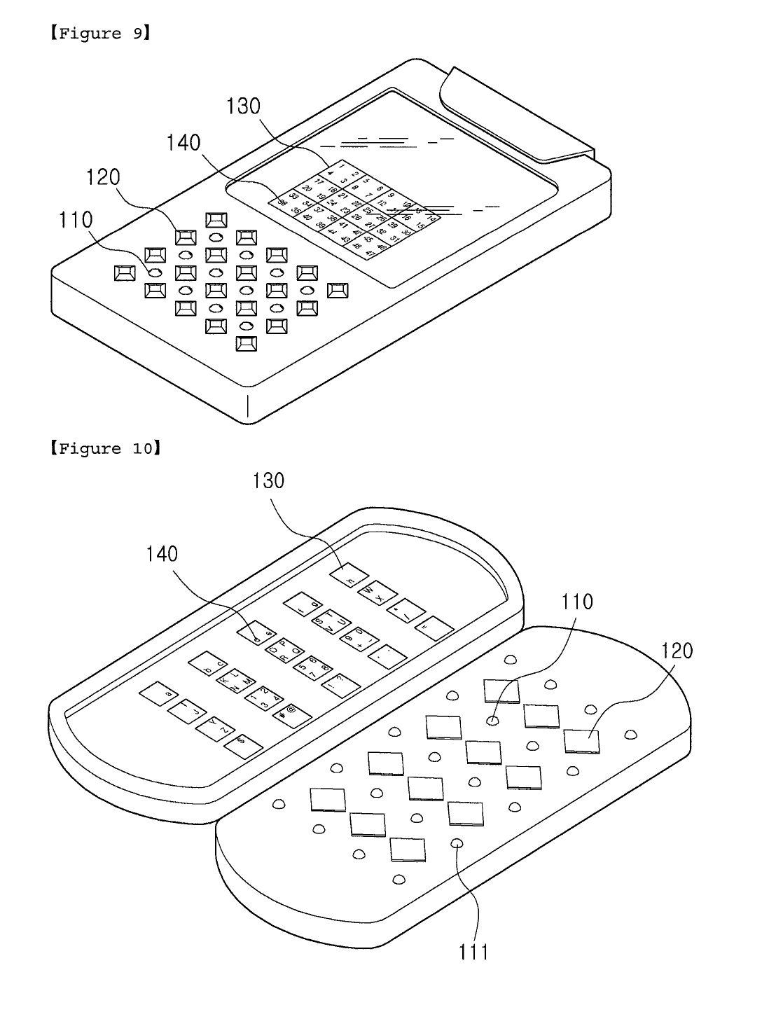

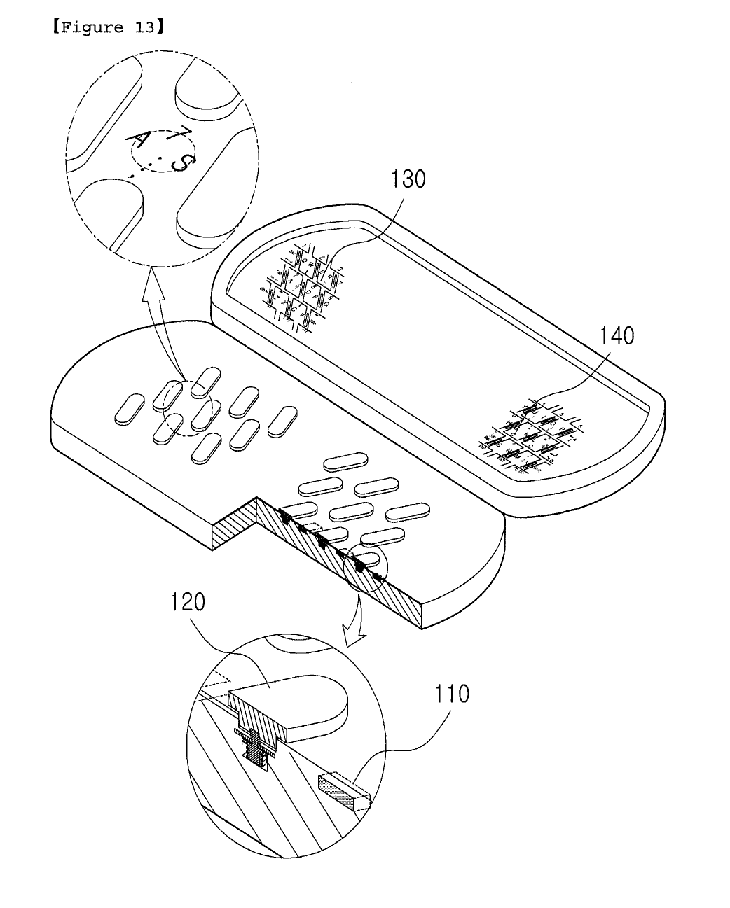

FIG. 1 is a drawing showing one embodiment of a data input apparatus according to the present invention, FIG. 2 is a drawing showing an input example of FIG. 1(a), FIG. 3 is a drawing showing an input example of FIG. 1(b), FIG. 4 is a drawing showing an input example of FIG. 1(c), FIG. 5 is a drawing showing a case of selecting a unit cell of the data input apparatus according to the present invention, FIG. 6 is a drawing showing when entering a key of the data input apparatus according to the present invention, FIG. 7 is a perspective view and an exploded perspective view showing the data input apparatus according to the present invention, FIG. 8 is a drawing showing an example of applying the data input apparatus according to the present invention to a portable terminal, FIG. 9 is a drawing showing an example of applying the data input apparatus according to the present invention to PDA, FIG. 10 is a perspective view showing an example of applying a data input apparatus according to other aspect of the present invention, FIG. 11 and FIG. 12 are perspective views showing an example of applying a data input apparatus according to further other aspect of the present invention, and FIG. 13 is a partial cross sectional perspective view of FIG. 11.

As shown, the data input apparatus according to the present invention is configured of a key input switch 120 which is disposed in a matrix pattern to define a unit cell 130 with switches located in all the vertex of a square; and a cell select switch 110 which is disposed in a center portion of the unit cell 130 consisted of the key input switches 120 and is touched or pressed to cause the unit cell 130 to be selected and set into a key input stand-by state.

The key input switch 120 is located in the vertex of the square and disposed in the matrix pattern to define the unit cell in which the unit cell and adjacent unit cell share at least one or more switches with each other.

The cell select switch 110 is disposed in a center portion of the unit cell of the key input switch 120 and is touched or pressed to cause the unit cell 130 to be selected and set into a key input standby state.

Subsequently, it is allowed to input a key value of corresponding unit cell 130 generated by a sequence pair consisted of a touching of the cell select switch 110 and an entering of the key input switch 120 when inputting the data.

After inputting the key value, the unit cell 130 activated by touching the cell select switch preferably remains activated until the adjacent unit cell 130 sharing the key input switch 120 is activated.

Further, according to the present invention, when two or more cell select switches are touched simultaneously upon entering the key input switch, the cell select is allowed which is corresponding to the cell select switch which is touch-initiated first. Alternatively when cell select switches are touched simultaneously, the cell select or the key input are prevented.

FIG. 1 is a drawing showing one embodiment of a data input apparatus according to the present invention; a) shows an example in which the cell select switch is located in a center portion of the 4 key input switches disposed in a matrix pattern, and b) shows an example in which one or more outermost cell select switches are additionally located on the same line as the cell select switch outside an outermost-disposed key input switch.

Also, c) of FIG. 1 further includes a key input switch 121 which is located on the same line as the key input switch 120 outside the outermost-disposed key input switch 120 to share the cell select switch 111 with each other, and at least one cell select switch 111 which is located on the same line as the cell select switch 110 outside the outermost-disposed key input switch 120.

A data input method of the data input apparatus according to the present invention will be hereinafter described specifically referring to (a) of FIG. 1 and FIG. 2,

For example, in a case of inputting “A”, if the user presses or touches the cell select switch corresponding to a unit cell Al shown in (a) of FIG. 1 to activate the unit cell A1, and then enters the key input switch b1 corresponding to “A” on the unit cell A1, “A” may be inputted. In a case of “C”, if the user presses or touches the cell select switch corresponding to the unit cell A1 to activate the unit cell A1, and then enters the key input switch b6 corresponding to “C” on the unit cell A1, “C” may be inputted.

In addition, in a case of inputting “H”, if the user presses or touches the cell select switch corresponding to a unit cell A2 shown in (a) of FIG. 1 to activate the unit cell A2, and then enters the key input switch b6 corresponding to “H” on the unit cell A2, “H” may be inputted.

Therefore, the cases of inputting “C” and “H” use different cell select switch but share the same key input switch A2. As such, according to the present invention, since adjacent unit cells can share the key input switch with each other, it is possible to reduce the number of the key input switch without a need of having such number of the key input switch as the number of key values and still input larger number of key values while. Further, it is possible to confirm the key position intuitively while minimizing movement of finger upon inputting the key.

In this case, the selected cell remains selected after inputting the cell select switch and the key value within the selected cell can be inputted several times.

A data input apparatus according to other aspect of the present invention is same as the data input apparatus mentioned above, except that at least one outermost cell select switch 111 is additionally located on the same line as the cell select switch 110 outside the outermost-disposed key input switch 120. At this time, the outermost cell select switch 111 is pressed or touched to cause the outermost-disposed key input switch 120 adjacent to it to be set into a key input standby. As shown in (b) of FIG. 1, the outermost cell select switch 111 is disposed in all of four faces outside the outermost-disposed key input switch 120.

Referring to (b) of FIG. 1 and FIG. 2, a data input method of the data input apparatus according to other aspect of the present invention will be hereinafter described specifically.

For example, in a case of inputting “K”, if the user presses or touches the cell select switch corresponding to a unit cell B7 shown in (b) of FIG. 1 to activate the unit cell B7, and then enters the key input switch b1 corresponding to “K” on the unit cell B7, “K” may be inputted. Similarly in a case of “M”, if the user presses or touches the cell select switch corresponding to the unit cell B7 shown in (a) of FIG. 1 to activate the unit cell B7, and then enters the key input switch b6 corresponding to “C” on the unit cell B7, “M” may be inputted.

In addition, in a case of inputting “R”, if the user presses or touches the cell select switch corresponding to a unit cell B8 shown in (b) of FIG. 1 to activate the unit cell B8, and then enters the key input switch b6 corresponding to “R” on the activated unit cell B8, “R” may be inputted.

Similarly, since the cases of inputting “M” and “R” use different cell select switch but share the same key input switch b6, it is possible reduce the number of the key input switch without a need of having such number of the key input switch as the number of key values.

In addition, the operation of the outermost cell select switch 111 will be hereinafter described.

In a case of inputting “A”, if the user presses or touches the cell select switch corresponding to a unit cell B1 shown in (b) of FIG. 1 to activate the unit cell B1, and then enters the key input switch b1 corresponding to “A” on the unit cell B1, “A” may be inputted. In a case of “B”, if the user presses or touches the cell select switch corresponding to a unit cell B2 to activate the unit cell B2, and then enters the key input switch b1 corresponding to “B” on the unit cell B2, “B” may be inputted.

As such, since the data input apparatus according to other aspect of the present invention is additionally installed with one or more outermost cell select switches 111 located on the same line as the cell select switch 110 outside the outermost-disposed key input switch 120 as compared with the above-mentioned data input apparatus, it is possible to input much more data.

Also, the key input switches 120 can be disposed in the matrix pattern to define square, rectangular, diamond or parallelogram shape as a whole.

As shown in FIGS. 1(a) and (b), the key input switches 120 may be disposed in the matrix pattern to define the rectangular shape as a whole. Particularly, FIG. 1(b) shows that is is additionally installed with one or more outermost cell select switches 111 which are located on the same line as the cell select switch outside the outermost-disposed key input switch.

FIG. 1(c) shows that the key input switches 120 are disposed in the matrix pattern to define the parallelogram shape as a whole and it is additionally installed with the key input switch 121 which is located on the same line as the key input switch 120 outside the outermost-disposed key input switch 120 to share the cell select switch 111 with each other, and one or more outermost cell select switches 111 located on the same line as the cell select switch 110 outside the outermost-disposed key input switch 120.

A data input method of the data input apparatus according to further other aspect of the present invention will be hereinafter described referring to (c) of FIG. 1 and FIG. 4.

For example, in a case of inputting “S”, if the user presses or touches the cell select switch corresponding to a unit cell C11 shown in (c) of FIG. 1 to activate the unit cell C11, and then enters the key input switch b2 corresponding to “S” on the unit cell C11, “S” may be inputted. In a case of “U”, the user presses or touches the cell select switch corresponding to the unit cell C11 shown in (c) of FIG. 1, and then enters the key input switch b6 corresponding to “U” on the unit cell C11, “U” may be inputted.

In a case of inputting “F”, if the user presses or touches the cell select switch corresponding to a unit cell C6 shown in (c) of FIG. 1 to activate the unit cell C6, and then enters the key input switch b1 corresponding to “F” on the activated unit cell C6, “F” may be inputted. In a case of inputting “H”, if the user presses or touches the cell select switch corresponding to the unit cell C6 to activate the unit cell C6, and then enters the key input switch b5 corresponding to “H” on the activated unit cell C6, “H” may be inputted.

In addition, in a case of inputting “A”, if the user presses or touches the cell select switch corresponding to a unit cell C1 shown in (c) of FIG. 1 to activate the unit cell C1, and then enters the key input switch b1 corresponding to “A” on the activated unit cell C1, “A” may be inputted. In a case of inputting “E”, if the user presses or touches the cell select switch corresponding to a unit cell C5 to activate the unit cell C5, and then enters the key input switch b1 corresponding to “E” on the activated unit cell C5, “E” may be inputted.

Also, in a case of inputting “Q”, if the user presses or touches the cell select switch corresponding to a unit cell C10 shown in (c) of FIG. 1 to activate the unit cell C10, and then enters the key input switch b1 corresponding to “Q” on he activated unit cell C10, “Q” may be inputted. In a case of inputting “R”, if one presses or touches the cell select switch corresponding to the unit cell C10 to activate the unit cell C10, and then enters the key input switch b5 corresponding to “R” on the unit cell C10, “R” may be inputted.

FIG. 5 is a drawing showing a case of selecting a unit cell of the data input apparatus according to the present invention; and FIG. 6 is a drawing showing when entering a key of the data input apparatus according to other aspect of the present invention. As shown in FIG. 5, if the cell select switch 110 is pressed or touched, the unit cell 130 defining key values corresponding to four key input switches 120 is selected to be set into the key input standby state. At this state, if the key input switch 120 is entered as shown in FIG. 6, the key value 140 corresponding to the unit cell 130 is selected to be inputted. The unit cells 130 have 4 key values respectively if the cell select switch 110 is pressed or touched, and one key value of four key values corresponding to the unit cell 130 is allowed to be selected using the key input switch 120.

At this time, if the cell select switch 110 is pressed or touched, the unit cell 130 corresponding to the cell select switch 110 is activated on the display 150. After pressing or touching the cell select switch 110, if one enters the key input switch 120 corresponding to the activated unit cell 130, corresponding key value 140 is inputted.

FIG. 7 is an exploded perspective view showing the data input apparatus according to the present invention. Herein, the key input switch 120 is made with a press switch. The key input switch 120 may be shaped in round, polygonal or rectangular form.

FIG. 8 is a drawing showing an example of applying the data input apparatus according to the present invention to a portable terminal; wherein (a) of FIG. 8 shows an example of implementing a telephone keypad with only key input switch, and (b) of FIG. 8 shows an example of implementing 24 input values by adding six cell select switches on the telephone keypad.

FIG. 9 is a drawing showing an example of applying the data input apparatus according to the present invention to PDA.

As shown, since the data input apparatus according to the present invention is allowed to share the key input switch with each other so that more key values can be inputted with less switches, it is possible to apply to PDA having many key values.

FIG. 10 is a drawing showing an example of applying a data input apparatus according to other aspect of the present invention.

As shown, one or more outermost cell select switches 111 are additionally located on the same line as the cell select switch 110 outside the outermost-disposed key input switch 120. At this time, if the outermost cell select switch 111 is pressed or touched, the outermost-disposed key input switch 120 adjacent to it is set into the key input standby state.

FIG. 11 and FIG. 12 show examples of applying a data input apparatus according to further other aspect of the present invention.

The data input apparatus of FIG. 11 shows that the matrix pattern of the key input switches defines a parallelogram, and it is additionally installed with the key input switch 121 which is located on the same line as the key input switch 120 outside the outermost-disposed key input switch 120 to share the cell select switch 111 with each other and one or more cell select switches 110 which are located outside the outermost-disposed key input switch 120. Further, the key input switches 120 are disposed left-right symmetrically about a central axis of a center portion, in which each of the key input switches 120 located on right side of the central axis is formed inclinedly from left top to right bottom and each of the key input switches 120 located in left side of the central axis is formed inclinedly from right top to left bottom.

As such, since the matrix pattern of the key input switches defines the parallelogram and the key input switch is straight-shaped and symmetrical about the central axis of the center portion in which each of the key input switches 120 located on left side of the central axis and each of the key input switches 120 located on right side of the central axis are inclinedly formed and straight-shaped, each of the key input switch 120 located on left side may be entered using left hand thumb and each of the key input switch 120 located on right side may be entered using right hand thumb, thereby making it possible to input easily using both hands.

In addition, the key input switches 120 is preferably disposed in the matrix pattern in such a way that the key input switch located outside may be inclined downwardly in order to prevent from intervening between the cell select switches.

Further, FIG. 11 and FIG. 12 show examples in which the data input apparatus according to further other aspect of the present invention is operated using both hands.

As shown, since the independently-operated data input apparatus is installed on both right and left sides respectively, the user may use the apparatus with both hands, thereby inputting the data conveniently.

Further, each of the key value 140 corresponding to the unit cell 130 selected due to a selection of the cell select switch 110 is printed on a portion close to the cell select switch 110 within the corresponding unit cell 130. At this time, the printed key value 140 may be displayed on the display 150 or on a plate in which the cell select switch 110 and the key input switch 120 are installed.

FIG. 13 is a partial cross sectional view of the data input apparatus according to the further other aspect of the present invention.

As shown, it is appreciated that the cell select switch 110 is embedded without being exposed to outside.

### INDUSTRIAL APPLICABILITY

The data input apparatus according to the present invention can cause the input position to be confirmed easily and the input operation to be performed rapidly and correctly with less number of cell selections, share the key input switch with each other and thereby input a large number of key values with less number of switches, implement more key values even in less area due to less number of switches, and reduce movements of fingers during input operations. Further, the present invention can allow the input position to be confirmed easily because of the step of selecting the unit cell which is a first input step, thereby allowing blind-touch operation.

1. A data input apparatus comprising:
a key input switch which is located in an adjacent vertex of a square and disposed in a matrix pattern to define a unit cell in which the unit cell and an adjacent unit cell share at least one or more switches with each other; and
a cell select switch which is installed on a center portion of the unit cell of the key input switch and is pressed or touched to cause the unit cell to be selected and set into a key input standby state,
wherein it is allowed to input a key value of the unit cell generated by a sequence pair consisted of a touching of the cell select switch and an entering of the key input switch.

2. The data input apparatus according to claim 1, wherein if the unit cell is activated, the key value is inputted by pressing the key input switch defining the activated unit cell.

3. The data input apparatus according to claim 1, further comprising a key input switch which is located on a same line as the key input switch outside the outermost-disposed key input switch to be allowed to share the cell select switch with each other.

4. The data input apparatus according to claim 1, further comprising one or more outermost cell select switches which are located on a same line as the cell select switch outside an outermost-disposed key input switch, wherein the outermost cell select switch is pressed or touched to cause the outermost-disposed key input switch adjacent to it to be set into a key input standby state.

5. The data input apparatus according to claim 1, wherein the cell select switch is pressed or touched to cause the unit cell consisted of adjacent key input switches to be activated, a key value assigned to the key input switch within the activated unit cell is inputted if a signal is inputted by pressing any one key input switch defining the activated unit cell, and the unit cell activated by touching the cell select switch remains activated until the adjacent unit cell sharing the key input switch is activated.

6. The data input apparatus according to claim 1, wherein the cell select is allowed which is corresponding to the cell select switch which is touch-initiated first, when two or more cell select switches are touched simultaneously.

7. The data input apparatus according to claim 1, wherein the cell select is prevented, when two or more cell select switches are touched simultaneously.

8. The data input apparatus according to claim 1, wherein each of the key values corresponding to the unit cell selected by selecting the cell select switch is printed on a portion close to the key input switch within the corresponding unit cell.

9. The data input apparatus according to claim 1, wherein the key input switch has a matrix pattern disposed in a square shape selected from a group consisted of a square, rectangular, diamond and parallelogram.

10. The data input apparatus according to claim 1, wherein the data input apparatus which is independently operated is installed in both left and right sides respectively to be used with both hands.
